(19) United States
(12) Patent Application Publication
(10) Pub. No.: US 2026/0264120 A1
(43) Pub. Date: Sep. 10, 2026

(54) TEMPORARY PIN REUSE SYSTEM

(71) Applicant: SK On Co., Ltd., Seoul (KR)

(72) Inventors: Jae Hyeok YU, Daejeon (KR); Eun Sol KO, Daejeon (KR)

(21) Appl. No.: 19/560,149

(22) Filed: Mar. 9, 2026

(30) Foreign Application Priority Data
Mar. 10, 2025 (KR) 10-2025-0030775

(51) Int. Cl. B08B 15/02; B08B 7/02; G01N 21/95; H01M 50/645

(52) U.S. Cl. CPC B08B 15/02; B08B 7/028; G01N 21/95; H01M 50/645

(57) ABSTRACT

Proposed is a temporary pin reuse system. The temporary pin reuse system may include a temporary pin removal module configured to remove a temporary pins of an electrode assembly during a manufacturing process, a first supply module configured to receive the temporary pin from the temporary pin removal module and to supply the temporary pin to a cleaning module, the cleaning module configured to receive the temporary pin from the first supply module and to clean the temporary pin, a reuse determination module configured to determine whether the temporary pin cleaned by the cleaning module is reusable, and a temporary pin insertion module configured to insert the temporary pin determined as a reusable temporary pin by the reuse determination module into the manufacturing process.

### CROSS REFERENCE TO RELATED APPLICATION

The present application claims priority to Korean Patent Application No. 10-2025-0030775, filed Mar. 10, 2025, the entire contents of which are incorporated herein for all purposes by this reference.

### BACKGROUND

### Technical Field

The present disclosure relates to a temporary pin reuse system.

### Description of the Related Art

Generally, a secondary battery is a battery which converts chemical energy into electrical energy and which is capable of being repeatedly used through a charging process that is a reverse process of a discharging process. Furthermore, a type of a secondary battery includes a nickel-cadmium (Ni-Cd) battery, a nickel-hydrogen (Ni-MH) battery, a lithium-metal battery, a lithium-ion (Li-Ion) battery, a lithium-ion polymer batteries (Li-Ion Polymer Battery, which is hereinafter referred to as “LIPB”), and so on are being developed.

Recently, since a secondary battery is widely used in the IT product field, the automobile field, the energy storage field, and so on, the secondary battery has been attracting attention as an energy source. In the IT product field, a secondary battery capable of long-term continuous use and enabling miniaturization and weight reduction is required. In the automobile field, a secondary battery having high power, durability, stability, and so on for eliminating the risk of explosion is required. In the energy storage field, surplus electric power generated from wind, solar power, and so on is stored in a secondary battery, and is used in a stationary manner, a secondary battery under relatively less stringent conditions may be applied to the energy storage field.

In a secondary battery manufacturing process, a process of inserting and removing a temporary pin is performed so as to prevent foreign substances from penetrating an electrolyte injection port of a secondary battery. Here, there is an increased need for effective reuse of such a temporary pin.

### SUMMARY

Accordingly, the present disclosure has been made keeping in mind the above problems occurring in the related art, and an objective of the present disclosure is to provide a temporary pin reuse system capable of effectively reusing a temporary pin used during a secondary battery manufacturing process, thereby being capable of increasing the reliability of the secondary battery manufacturing process, reducing indiscriminate use of resources, and lowering carbon emissions.

According to an embodiment of the present disclosure, there is provided a temporary pin reuse system including: a temporary pin removal module configured to remove a temporary pin of an electrode assembly during a manufacturing process; a first supply module configured to receive the temporary pin from the temporary pin removal module and to supply the temporary pin to a cleaning module; the cleaning module configured to receive the temporary pin from the first supply module and to clean the temporary pin; a reuse determination module configured to determine whether the temporary pin cleaned by the cleaning module is reusable; and a temporary pin insertion module configured to insert the temporary pin determined as a reusable temporary pin by the reuse determination module into the manufacturing process.

Here, the temporary pin reuse system may further include a second supply module configured to supply the temporary pin determined as the reusable temporary pin by the reuse determination module to the temporary pin insertion module.

In addition, the cleaning module may include: a mesh plate on which the temporary pin is seated; an ionizer configured to separate particles from the temporary pin; and a collector unit including an intake fan so as to collect the separated particles.

In addition, the cleaning module may further include a filter unit configured to filter out the particles from the temporary pin.

In addition, the cleaning module may further include an ultrasonic generator configured to perform ultrasonic cleaning of the temporary pin.

In addition, the reuse determination module may include: an inspection module configured to measure an external shape and a color of the temporary pin; and a determination module configured to determine reusability of the temporary pin on the basis of values measured by the inspection module.

In addition, when the temporary pin is determined as a reusable temporary pin by the determination module, the temporary pin may be supplied to the temporary pin insertion module. In addition, when the temporary pin is determined as a not reusable temporary pin by the determination module, the temporary pin may be discharged to a discharge unit. Furthermore, the temporary pin reuse system may further include: a counting module configured to count the number of times the temporary pin is determined as reusable by the determination module; and an artificial-intelligence module configured to store data on an allowable reuse cycle of the temporary pin through the counting module and to learn the allowable reuse cycle on the basis of the stored data.

In addition, when a final reuse cycle of the temporary pin is counted by the counting module on the basis of a learning result of the allowable reuse cycle of the temporary pin, the artificial-intelligence module may transmit corresponding data to the first supply module, so that the first supply module may discharge the temporary pin to the discharge unit when the temporary pin having completed the final reuse cycle is supplied from the temporary pin removal module to the first supply module.

In addition, the artificial-intelligence module may be configured to store data measured by the inspection module when the determination module performs reusability determination, may be configured to perform learning of reusability inspection result data corresponding to a reuse cycle of the temporary pin, and may be configured to compute a service life of the temporary pin.

The features and advantages of the present disclosure will be more clearly understood from the following detailed description based on the accompanying drawings.

The terms and words used in the present specification and claims should not be interpreted as being limited to typical meanings and dictionary definitions, but should be interpreted as having meanings and concepts relevant to the technical scope of the present disclosure based on the rule according to which an inventor can appropriately define the concept of the term to describe most appropriately the best method he or she knows for carrying out the present disclosure.

According to an aspect of the present disclosure, since the reliability of temporary pin removal and reinsertion processes in the secondary battery manufacturing process are increased, there is an effect that the reliability of the secondary battery manufacturing process in which the temporary pin is reused may be increased.

In addition, since the number of reuse cycles and service life of the temporary pin during the removal and reinsertion processes is effectively inspected and verified, the utilization of temporary pin reuse may be increased, so that there is an effect that carbon emissions may be reduced through resource reuse.

Furthermore, since the artificial-intelligence module is applied for the temporary pin removal and reinsertion processes, there is an effect that an effective pretreatment for the reuse of the temporary pin according to reuse cycles of the temporary pin may be designed.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a schematic process diagram illustrating a temporary pin reuse system according to an embodiment of the present disclosure;

FIG. 2 is a schematic view illustrating a cleaning module of the temporary pin reuse system according to an embodiment of the present disclosure;

FIG. 3 is a schematic view illustrating an inspection module of the temporary pin reuse system according to an embodiment of the present disclosure; and

FIG. 4 is an operational flowchart of the temporary pin reuse system according to an embodiment of the present disclosure.

### DETAILED DESCRIPTION

The terms used in the present disclosure are used to describe an embodiment, and are not intended to limit the present disclosure. Singular expressions include plural expressions unless the context clearly indicates otherwise.

In adding reference numerals to components throughout the drawings, it is to be noted that like or similar reference numerals designate like or similar components even though the components are illustrated in different drawings.

The drawings may be exaggerated or shown schematically for description of an embodiment. In the present document, expressions such as “include”, “may include”, “comprise”, “may comprise” and so on used herein indicate existence of corresponding features (for example, numeric values, functions, operations, or components such as parts), and does not exclude existence of additional features.

The terms “one”, “other”, “another”, “first”, “second”, and so on are used to differentiate one constituent element from another constituent element, and these constituent elements should not be limited by these terms.

Hereinafter, an embodiment of the present disclosure will be described in detail with reference to the accompanying drawings.

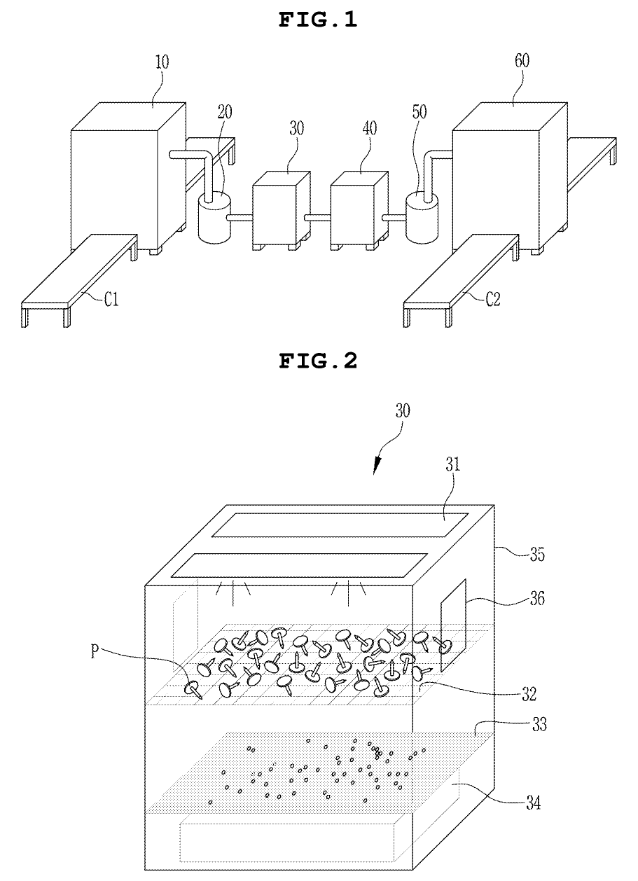

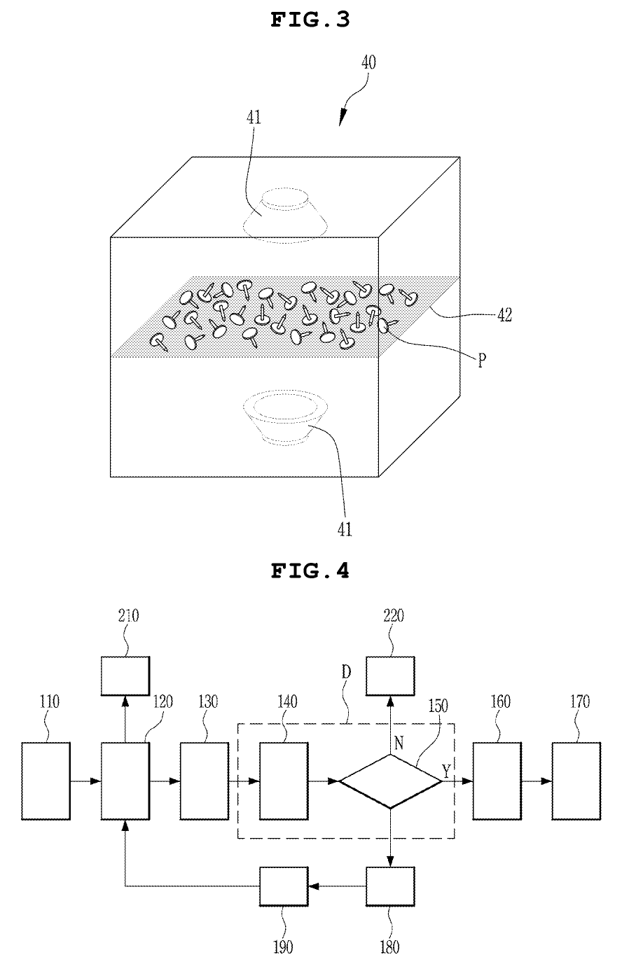

FIG. 1 is a schematic process diagram illustrating a temporary pin reuse system according to an embodiment of the present disclosure, FIG. 2 is a schematic view illustrating a cleaning module of the temporary pin reuse system according to an embodiment of the present disclosure, FIG. 3 is a schematic view illustrating an inspection module of the temporary pin reuse system according to an embodiment of the present disclosure, and FIG. 4 is an operational flowchart of the temporary pin reuse system according to an embodiment of the present disclosure.

According to an embodiment of the present disclosure, a temporary pin reuse system may include: a temporary pin removal module 110 configured to remove a temporary pin P of an electrode assembly during a manufacturing process; a first supply module 120 configured to receive the temporary pin P from the temporary pin removal module 110 and to supply the temporary pin P to a cleaning module 130; the cleaning module 130 configured to receive the temporary pin P from the first supply module 120 and to clean the temporary pin P; a reuse determination module D configured to determine whether the temporary pin P cleaned by the cleaning module 130 is reusable; and a temporary pin insertion module 170 configured to supply the temporary pin P determined as a reusable temporary pin by the reuse determination module D to the manufacturing process.

FIG. 1 is a schematic view illustrating device components in a general process for operating the temporary pin reuse system according to an embodiment of the present disclosure.

As illustrated in FIG. 1, in a secondary battery manufacturing process, during a first side process C1 performed in one direction and a second side process C2 performed in an opposite direction, the temporary pin P used in the first side process C1 may be removed, a predetermined process may be performed, and the temporary pin P may be inserted into the second side process C2 so as to reuse the temporary pin P.

In the present disclosure, the temporary pin P is exemplified as a component used to temporarily seal an electrolyte injection port during the secondary battery manufacturing process, and the temporary pin reuse system for maximally reusing the temporary pin P without compromising process reliability is proposed. However, the temporary pin reuse system of the present disclosure is not limited to the secondary battery manufacturing process, and may be applied to induce reuse of other disposable components consumed in a similar manner.

First, as illustrated in FIG. 1, a temporary pin remover 10 is configured to remove the temporary pin P used in the first side process C1. After the removed temporary pin P is transferred to a first supply device 20, the first supply device 20 transfers the temporary pin P to a process for reuse. That is, the temporary pin P is cleaned first by a cleaner 30 and then is transferred to an inspection device 40 for examining and determining the reusability of the cleaned temporary pin P. Through a series of inspections and determinations performed by the inspection device 40, a reusable temporary pin P is transferred to a temporary pin insertion device 60 via a second supply device 50 to supply the reusable temporary pin P to the second side process C2.

As illustrated in FIG. 2, the cleaner 30 configured to clean the temporary pin P may separate particles such as dust from the temporary pin P seated on a mesh plate 32 by using an ionizer 31. When foreign substances attached to the temporary pin P are separated from the temporary pin P, the foreign substances fall downward through the mesh plate 32 on which the temporary pin P is seated.

The particles and foreign substances falling downward are filtered again by a filter unit 33, and are finally discharged to a collector unit 34 by an intake fan (not illustrated).

A housing accommodating the temporary pin P may further be provided as an ultrasonic cleaner 35 capable of performing ultrasonic cleaning by an ultrasonic generator. This is to prevent chemical reactions or to prevent foreign substances from being introduced into the secondary battery manufacturing process when the temporary pin P is reused.

Transportation of the temporary pin P may be implemented by retrieving the temporary pin P along an inclined vibratory plate or by retrieving the temporary pin P through a conveyor. A shelter 36 where the temporary pin P can enter and exit may be formed on both sides of the cleaner 30 so that the shelter 36 serves as a passage for inserting the temporary pin P into the cleaner 30.

When the temporary pin P has undergone physical and chemical cleaning by the cleaner 30, reusability of the temporary pin P is then determined.

The inspection device 40 may determine the degree of wear or durability of the temporary pin P on the basis of a physical shape of the temporary pin P after cleaning, and may determine whether chemical contaminants have come into contact with the temporary pin P on the basis of external discoloration or surface color changes of the temporary pin P.

Specifically, as illustrated in FIG. 3, the temporary pin P may be inspected from above and below by a vision sensor unit 41 so as to evaluate the shape change or the surface discoloration of the temporary pin P, thereby determining reusability. The temporary pin P may be positioned on a transparent plate 42, and the vision sensor unit 41 may inspect a three-dimensional shape and the surface discoloration of the temporary pin P from all directions including upper and lower sides of the temporary pin P. Although the vision sensor unit 41 is illustrated in an embodiment of the present disclosure, a sensor and a measuring device may be redesigned or optimized according to the type of process to which the temporary pin P is applied.

FIG. 4 is an operational flowchart of the temporary pin reuse system according to an embodiment of the present disclosure. Hereinafter, an operation of the system using the physical device components of the temporary pin reuse system according to an embodiment of the present disclosure will be described in detail.

The temporary pin removal module 110 is configured to remove the temporary pin P from the electrode assembly during the manufacturing process. Here, the temporary pin P may be used to temporarily seal the electrolyte injection port of the electrode assembly, and is removed once the corresponding process is completed. However, as described above, the process to which the temporary pin P is applied is not limited to the secondary battery manufacturing process exemplified in the present disclosure.

The first supply module 120 is configured to receive the temporary pin P from the temporary pin removal module 110 and to supply the temporary pin P to the cleaning module 130. Otherwise, as described later, the first supply module 120 may supply the temporary pin P to discharge units 210 and 220 for discharging the temporary pin P after reuse.

The cleaning module 130 is configured to receive the temporary pin P from the first supply module 120 and to clean the temporary pin P. The cleaning module 130 may clean the temporary pin P by using the cleaner 30 described earlier. Specifically, foreign substances attached to the temporary pin P are removed and the temporary pin P is cleaned by using the ultrasonic cleaner 35. The cleaning module 130 may include the mesh plate 32 for seating the temporary pin P thereon, the ionizer 31 for separating particles from the temporary pin P, and the collector unit 34 including the intake fan for collecting separated particles.

The cleaning module 130 is already described with reference to FIGS. 1 and FIG. 2, so that detailed repetitive descriptions will be omitted.

The reuse determination module D may determine whether the temporary pin P cleaned by the cleaning module 130 is reusable. The reuse determination module D may include an inspection module 140 configured to measure a shape, a color, and so on of the temporary pin P, and may include a determination module 150 configured to determine whether the temporary pin P is reusable on the basis of values measured by the inspection module 140.

The inspection module 140 may perform inspection of the temporary pin P by using the inspection device 40 in FIG. 3 already described. Once data of the temporary pin P that is inspected by the inspection module 140 is accumulated and stored, the determination module 150 may determine the reusability of the temporary pin P on the basis of the stored data. The determination module 150 may set a predetermined setting value for a reference shape or appearance of the temporary pin P, and may modify the predetermined setting value or may add a predetermined setting value by using an artificial-intelligence module 190 that will be described later.

The determination module 150 may inspect a detailed external shape of the temporary pin P so as to reuse the temporary pin P. That is, the determination module 150 may inspect a physical form deformation and so on of the temporary pin P including a functional shape of the temporary pin P necessary for an operation of the temporary pin P. In addition, the inspection module 150 may determine chemical changes, discoloration, or reuse stability of the temporary pin P on the basis of the color of the temporary pin P.

Once the reuse determination is completed and it is determined that the temporary pin P is reusable, the temporary pin P may be supplied to the temporary pin insertion module 170 at the second side process through a second supply module 160.

If the determination module 150 determines that the temporary pin P is not reusable, the temporary pin P may be discharged. In this case, when the temporary pin P is transferred to the second supply module 160, the second supply module 160 may discharge the temporary pin P to the discharge unit 220 so that the temporary pin P is discarded and is not reused.

A counting module 180 configured to count and store the number of times the temporary pin P is determined as reusable by the determination module 150 when the determination module 150 determines the reusability of the temporary pin P may further be included.

The counting module 180 may count the number of reuse determinations performed by the determination module 150 for the temporary pin P, and may store data indicating how many times an individual temporary pin P can be reused in real time.

The counting module 180 may store data regarding a maximum allowable number of reuse determinations of the temporary pin P, and the artificial-intelligence module 190 configured to learn the maximum allowable number of reuse determinations of the temporary pin P on the basis of the stored data may further be included.

When the counted number of reuse determinations reaches the maximum allowable number of reuse determinations learned by the artificial-intelligence module 190, the artificial-intelligence module 190 may transmit this information to the first supply module 120. Therefore, when the temporary pin P is transferred to the first supply module 120 through the temporary pin removal module 110, the first supply module 120 may directly discharge the temporary pin P to the external discharge unit 210 without supplying the temporary pin P to the cleaning module 130. Therefore, unnecessary inspection and determination operations may be avoided, so that efficiency of the temporary pin reuse system and productivity of the temporary pin P may be increased.

When reuse determination is performed by the determination module 150, data measured by the inspection module 140 may be stored together with reuse cycle information of the temporary pin P so that matching learning of reusability according to the reuse cycle may be performed. Through this, a service life of the temporary pin P may be computed and additional information may be provided to a user.

As the artificial-intelligence module 190 accumulates and utilizes repeated learning data on the temporary pin reuse system, the artificial-intelligence module 190 may select a shape or an applicable material that can increase the reuse cycle of the temporary pin P. Accordingly, not only effective reuse of the temporary pin P but also structural design of the temporary pin P for reuse may be achieved by the temporary pin reuse system according to an embodiment of the present disclosure.

The present disclosure has been described in detail through specific embodiments. The embodiment is proposed to more concretely describe the present disclosure. However, the embodiment is only given for illustrating the present disclosure and those skilled in the related art will obviously understand that various alterations and modifications are possible within the scope and spirit of the present disclosure. Such alterations and modifications are duly included in the appended claims.

What is claimed is:

1. A temporary pin reuse system comprising:
a temporary pin removal module configured to remove a temporary pin of an electrode assembly during a manufacturing process;
a first supply module configured to receive the temporary pin from the temporary pin removal module and to supply the temporary pin to a cleaning module;
the cleaning module configured to receive the temporary pin from the first supply module and to clean the temporary pin;
a reuse determination module configured to determine whether the temporary pin cleaned by the cleaning module is reusable; and
a temporary pin insertion module configured to insert the temporary pin determined as a reusable temporary pin by the reuse determination module into the manufacturing process.

2. The temporary pin reuse system of claim 1, further comprising:
a second supply module configured to supply the temporary pin determined as the reusable temporary pin by the reuse determination module to the temporary pin insertion module.

3. The temporary pin reuse system of claim 1, wherein the cleaning module comprises:
a mesh plate on which the temporary pin is seated;
an ionizer configured to separate particles from the temporary pin; and
a collector unit including an intake fan so as to collect the separated particles.

4. The temporary pin reuse system of claim 3, wherein the cleaning module further comprises a filter unit configured to filter out the particles from the temporary pin.

5. The temporary pin reuse system of claim 3, wherein the cleaning module further comprises an ultrasonic generator configured to perform ultrasonic cleaning of the temporary pin.

6. The temporary pin reuse system of claim 1, wherein the reuse determination module comprises:
an inspection module configured to measure an external shape and a color of the temporary pin; and
a determination module configured to determine reusability of the temporary pin on the basis of values measured by the inspection module.

7. The temporary pin reuse system of claim 6, wherein, when the temporary pin is determined as a reusable temporary pin by the determination module, the temporary pin is supplied to the temporary pin insertion module,
wherein, when the temporary pin is determined as a not reusable temporary pin by the determination module, the temporary pin is discharged to a discharge unit, and
wherein the temporary pin reuse system further comprises:
a counting module configured to count the number of times the temporary pin is determined as reusable by the determination module; and
an artificial-intelligence module configured to store data on an allowable reuse cycle of the temporary pin through the counting module and to learn the allowable reuse cycle on the basis of the stored data.

8. The temporary pin reuse system of claim 7, wherein, when a final reuse cycle of the temporary pin is counted by the counting module on the basis of a learning result of the allowable reuse cycle of the temporary pin, the artificial-intelligence module transmits corresponding data to the first supply module, so that the first supply module discharges the temporary pin to the discharge unit when the temporary pin having completed the final reuse cycle is supplied from the temporary pin removal module to the first supply module.

9. The temporary pin reuse system of claim 7, wherein the artificial-intelligence module is configured to store data measured by the inspection module when the determination module performs reusability determination, is configured to perform learning of reusability inspection result data corresponding to a reuse cycle of the temporary pin, and is configured to compute a service life of the temporary pin.
